(19) United States
(12) Patent Application Publication
(10) Pub. No.: US 2012/0043496 A1
(43) Pub. Date: Feb. 23, 2012

(54) POROUS, MAGNETIC SILICA GEL MOLDED PARTS, PRODUCTION THEREOF, AND APPLICATION THEREOF

(75) Inventors: Karin Cabrera Perez, Dreieich (DE); Anita Leinert, Ober-Ramstadt (DE)

(73) Assignee: MERCK PATENT GESELLSCHAFT MIT BESCHRANKTER HAFTUNG, Darmstadt (DE)

(21) Appl. No.: 13/264,787

(22) PCT Filed: Mar. 17, 2010
(86) PCT No.: PCT/EP2010/001685

§ 371 Date: Oct. 17, 2011

(30) Foreign Application Priority Data
Apr. 17, 2009 (DE) 10 2009 017 943.7

(51) Int. Cl. H01F 1/37

(52) U.S. Cl. 252/62.54

(57) ABSTRACT

The present invention relates to porous, magnetic silica-gel mouldings having novel properties, by means of which separations of substances from reaction solutions and solid-phase reactions are simplified. In addition, a process for the preparation of these separation materials and possible applications thereof are described.

The present invention relates to porous, magnetic or magnetisable silica-gel mouldings having novel properties, by means of which certain substance separations and organic reactions are simplified. In addition, a process for the production of these mouldings and possible applications thereof are described.

### PRIOR ART

It is known to employ magnetic particles for a very wide variety of applications; for example in medicine (drug delivery, hyperthermia therapy, contrast agent for MRI=magnetic resonance imaging) and diagnostics. However, applications in molecular biology and separation technology are also known. In addition, particles of this type can also be employed, inter alia, in magnetic data storage.

Magnetic particles have a magnetic core, for example comprising maghaemite (γ-Fe₂O₃) or magnetite (Fe₃O₄) or comprising other metal oxides or metal compounds. These particles can be provided with coatings in various ways. Thus, corresponding magnetic particles are known which are coated, for example, with silanes, a very wide variety of organic polymers or natural biopolymers (chitosan, gelatine, etc.). Owing to the respective coatings, these materials can be employed for various industrial applications.

Of particular interest in current research is the production of ever-smaller particles, in particular having sizes in the order of the nanometre range, where materials having particularly narrow particle-size distributions (if possible monodisperse) are desirable in order to be able to use them for medical applications and, where appropriate through suitable functionalisations, to make them biocompatible.

Since the common magnetic particles are non-porous materials, they generally have only small surface areas (for example <50 m²/g). However, large surface areas are always desirable if substance separations are to be carried out and if substance components are to be isolated from a liquid or gaseous mixture. This is of importance, in particular, if, for example, large amounts of liquid are to be treated in the shortest possible time and specific ingredients are optionally to be bound and removed selectively or substance separations are to be carried out specifically. Large surface areas or high capacities are necessary for this purpose. Large surface areas are also required if organic reactions are to be carried out using bound reactants (for solid-phase reactions, such as, for example, Merrifield reactions) on a solid. The larger the surface area, the greater the bound proportion of the reactant and the more efficient the organic reaction.

A disadvantage of the use of particulate particles for the selective separation of substances from substance mixtures or for solid-phase reactions is the complex separation of the particles after adsorption from the substance mixture or after the reaction if the particulate adsorbent is added, analogously to active carbon, to the liquid substance or reaction mixture, since a special device which is suitable for separating off the particles from the substance mixture with the aid of a magnetic field must be present for the separation of the particulate, magnetic adsorbent.

On the other hand, Leventis et al. (Nano Lett. Vol. 2, No. 1, 2002, pp. 63-66) describe silica-gel monoliths into which magnetic particles have been polymerised. However, these silica-gel monoliths have proven unsuitable for practical use for the separation of reaction products from liquid mixtures since they are not dimensionally stable and easily disintegrate or crumble under the application conditions. In addition, silica-gel monoliths produced in accordance with Leventis do not have an interconnecting pore structure, meaning that on the one hand the surface areas available for adsorption/desorption or for the solid-phase reaction are small and on the other hand adequate liquid exchange cannot take place in the monolith used.

### OBJECT OF THE INVENTION

The object of the present invention is therefore to provide mouldings which on the one hand are magnetic or magnetisable and on the other hand have the largest possible surface area. In addition, the pore structure should enable liquids to flow through the moulding.

### ACHIEVEMENT OF THE OBJECT

It has been found that magnetic or magnetisable porous mouldings having through-flow pores can be provided if they are produced by a sol-gel process in which magnetic or magnetisable particles are added to the reaction solution.

The present invention therefore relates to mouldings having through-flow pores which comprise magnetic or magnetisable particles.

In a preferred embodiment, the moulding essentially consists of silica gel or silica-gel hybrid materials.

In a preferred embodiment, the moulding comprises magnetic or magnetisable particles which have a core or layer of iron oxide, such as maghaemite (γ-Fe₂O₃) or magnetite (Fe₃O₄).

In another preferred embodiment, the mouldings have a bimodal pore distribution with macroporous through-flow pores having a pore diameter of greater than 0.1 μm and mesopores having a pore diameter of between 2 and 200 nm.

In another preferred embodiment, the moulding has a cylindrical shape.

In another preferred embodiment, the moulding comprises magnetic or magnetisable particles whose surface has hydroxyl groups.

In a preferred embodiment, the moulding has been functionalised by means of separation effectors.

In another embodiment, the moulding is completely or partly surrounded by a sheath layer.

The present invention also relates to a process for the production of mouldings having through-flow pores which comprise magnetic or magnetisable particles by a sol-gel process in which magnetic or magnetisable particles are added to the reaction mixture.

In a preferred embodiment, the reaction mixture comprises alkoxysilanes and/or organoalkoxysilanes.

The present invention also relates to the use of the mouldings according to the invention for the enrichment or isolation of analytes from liquid media, as support materials for solid-phase reactions, as support materials for catalysts, enzymes, antibodies or other reactants.

In a preferred embodiment, the moulding according to the invention is used as stirrer bar in a liquid medium. During the reaction, the moulding employed as stirrer bar can serve for the isolation of desired reaction products from the medium.

The individual aspects or subject-matters of the invention described above can also be achieved in any desired combination of two or more aspects or subject-matters.

In accordance with the invention, a moulding is a three-dimensional body. Mouldings are frequently also called monolithic mouldings or monoliths. Examples of mouldings are regularly shaped, for example round, or irregularly shaped bodies. Mouldings are preferably three-dimensional bodies which have a length of greater than 1 mm in at least one dimension (for example height, width or depth). Particular preference is given in accordance with the invention to cuboid or columnar (cylindrical) bodies. The moulding according to the invention can be produced in any desired shape. This can be produced, for example, by selecting a gelling vessel having a corresponding shape during production of the moulding or treating the moulding by mechanical action, such as, for example, grinding or cutting, after production and bringing it into the desired shape. In particular, mouldings having small and/or irregular shapes can be produced from larger mouldings by mechanical action. Preference is given in accordance with the invention to elongate mouldings, i.e. mouldings which have a greater dimension in one direction than in the two other directions, or disc-shaped mouldings. Particular preference is given to columnar or cylindrical mouldings. In the case of porous mouldings, the solids content or framework comprising, for example, silica gel is in accordance with the invention also referred to as skeleton in order to enable differentiation from the pores.

Magnetic or magnetisable particles are in accordance with the invention particles which either have inherent magnetism, i.e. are magnetic without external influence, or those which do not have an inherent magnetic field, but form a magnetic dipole when exposed to a magnetic field. Correspondingly, the term “magnetic or magnetisable particles” encompasses, for example, paramagnetic, superparamagnetic, ferrimagnetic or ferromagnetic materials. It is apparent to the person skilled in the art that only magnetisable particles which exhibit this property under the later application conditions—in particular at the temperature at which the mouldings according to the invention are later to be employed—are employed in accordance with the invention.

Particles are solid materials which have a small diameter. Particles are often also referred to as pigments. They are, for example, round, flake-form, elongate or irregularly shaped. The magnetic or magnetisable particles employed in accordance with the invention are preferably round or irregularly shaped. The size of the particles is very variable. Typical diameters are between 5 nm and 100 μm, preferably between 25 nm and 80 μm. The particles may be porous or non-porous. The particles may consist of one material or be built up—for example in layers—from various components.

Through-flow pores are pores or channels which allow, for example, a liquid or a gas to flow through a moulding. The liquid can enter the moulding at one point and exit again at another point. Correspondingly, pores which are only in the form of a notch in the surface of a moulding are not through-flow pores.

The mouldings according to the invention which comprise magnetic or magnetisable particles are mouldings in which the magnetic or magnetisable particles are distributed in the moulding. In the case of the porous mouldings according to the invention, the magnetic or magnetisable particles are distributed in the skeleton of the moulding. The magnetic or magnetisable particles are preferably polymerised into the moulding. The particles here may be distributed homogeneously to inhomogeneously in the moulding. The type of distribution of the particles in the moulding can be influenced by the way in which the process is carried out. In general, the mouldings according to the invention are produced by means of a sol-gel process. An inhomogeneous distribution can be produced, for example, if the synthesis is carried out in the presence of a magnetic field or the gelling mould in which the synthesis is carried out is stored in such a way that a majority of the particles is able to sink to the bottom of the gelling mould before final gelling. If the particles are homogeneously distributed in the reaction solution by stirring before final gelling and are transferred into the gelling mould just before final gelling, mouldings having a more homogeneous distribution of the particles, visually evident as marbled, thus form. In order to achieve a very homogeneous distribution, the gelling mould can, for example, be agitated or shaken moderately before and during final gelling.

“Mouldings essentially comprising silica gel or silica-gel hybrid materials” means in accordance with the invention that the principal constituent of the moulding, more precisely the principal constituent of the skeleton of the moulding, consists of silica gel or silica-gel hybrid materials. In addition, the moulding naturally comprises in accordance with the invention the magnetic or magnetisable particles. Furthermore, further additives, such as pigments, fibres or the like, can be added to the moulding during production. In addition, the moulding can be derivatised on the surface, for example by means of separation effectors, after production. Besides the magnetic or magnetisable particles, the mouldings according to the invention which essentially consist of silica gel or silica-gel hybrid materials usually have no further constituents whose proportion exceeds 5%, preferably 3%, of the total weight.

Silica-gel hybrid materials are materials which, in contrast to pure silica-gel materials, do not consist only of SiO₂. Instead, one or more organoalkoxysilanes are additionally used during the preparation thereof instead of or preferably in addition to the alkoxysilanes which are usual for the preparation of silica-gel materials. The proportion of the organoalkoxysilanes is usually at least 10%, preferably between 15 and 50% (mol %). However, organoalkoxysilanes can also be employed in amounts up to 100%. Organoalkoxysilanes are silanes in which one to three alkoxy groups, preferably one alkoxy group, of a tetraalkoxysilane have been replaced by organic radicals, such as, preferably, C1 to C20 alkyl, C2 to C20 alkenyl or C5 to C20 aryl, particularly preferably C1 to C8 alkyl. Examples of particularly suitable organoalkoxysilanes are methyltrimethoxysilane, ethyltrimethoxysilane, vinyltrimethoxysilane, methyltriethoxysilane, ethyltriethoxysilane, bis-functional silanes of the formula I

(RO)₁₋₃—Si—(CH₂)n—Si—(OR)₁₋₃ I

where R is typically an alkyl, alkenyl or aryl radical, such as C1 to C20 alkyl, C2 to C20 alkenyl or C5 to C20 aryl, preferably a C1 to C8 alkyl radical, and

n is preferably 1 to 8.

Examples of preferred compounds are BTME (bis(trimethoxysily)ethane, where R=methyl and n=2), bis(triethoxysilyl)ethane, bis(triethoxysilyl)-methane and bis(triethoxysilyl)octane.

Further organoalkoxysilanes are disclosed, for example, in WO 03/014450 or U.S. Pat. No. 4,017,528. In addition, these documents disclose the production of particles or monolithic mouldings from organoalkoxysilanes.

Particles which are suitable in accordance with the invention are all particles which are magnetic or magnetisable. These are preferably particles from the group of the iron oxides, such as maghaemite (γ-Fe₂O₃) or magnetite (Fe₃O₄), barium ferrite, zinc ferrite or cobalt ferrite, comprising elemental cobalt or magnetic or magnetisable mica particles. Finely particulate chromium oxides, cobalt oxides or zinc oxides can also be employed. The particles may be built up homogeneously from one material or consist of various materials. The particles may consist, for example, of a non-magnetic material into which smaller magnetic or magnetisable particles are in turn introduced or polymerised. In the same way, the particles may also have a magnetic or magnetisable core, such as, for example, magnetite particles, or one or more magnetic or magnetisable constituents, such as, for example, particles which have a core comprising a non-magnetic constituent, which is surrounded by a layer of a magnetic or magnetisable material. Examples thereof are inorganic particles, for example mica, titanium dioxide, silicon dioxide or calcium carbonate, which have been coated with Fe₃O₄. In addition, the particles may have further layers or functionalities, such as, for example, a coating with SiO₂ and/or zirconium oxide and/or Al₂O₃ and/or TiO₂.

In accordance with the invention, a layer means that a core is completely or partly sheathed by a further material. The sheathing here does not have to be complete. The term layer is also used in accordance with the invention if a further material which only partly covers the core is applied.

Particles which are suitable in accordance with the invention are, for example, iron particles (10 μm) [Art. No. 1.03819.0100 (Merck KGaA)] or Micona Matte Black [Art. No. 17437 (Merck KGaA)] and Mica Black [Art. No. 17260 (Merck KGaA)], i.e. mica particles which have been coated with iron oxide and, in the case of Mica Black, additionally with titanium dioxide.

The particles are preferably employed in an amount of 0.5 to 10 g, preferably 2 to 5 g, of magnetic particles, based on 50 ml of skeleton former (for example TMOS), where the skeleton former represents the base reagent for the formation of the silica-gel skeleton, i.e. in general the amount of alkoxysilanes or organoalkoxysilanes employed.

The production of magnetic or magnetisable particles is known to the person skilled in the art.

Maghaemite and magnetite can be prepared particularly simply in nanoparticulate form by precipitation reactions. Magnetite is usually prepared by precipitation from a strongly alkaline solution of Fe(II) and Fe(III) salts in the stoichiometric ratio 1:2 (Massart, IEE Trans. Magn. 1981, MAG-17, 1247). The reaction conditions (temperature, concentrations, reaction duration, type of lye, etc.) can be varied in broad ranges. The particles produced in this way usually have a very small diameter (7-10 nm). Subsequent oxidation of the magnetite gives maghaemite, which has similar magnetic properties. The very small particle size of <10 nm results in the iron oxide being superparamagnetic, i.e. in it exhibiting ferrimagnetic properties only in the presence of an external magnetic field and having no magnetic remanence. This is a general phenomenon of all ferri- and ferromagnetic materials in the case of sufficiently small particle sizes. The result of this is therefore that the particle size is in the same order of magnitude as the Weiss domains, which can be regarded as the smallest elemental-magnetic domains. In the case of magnetite, this size is in the order of about 30 nm. Magnetite particles having significantly larger average diameters are thus no longer superparamagnetic. Superparamagnetism is a desirable or vital property in the majority of applications since nanoparticles having remanent magnetism act as small permanent magnets and would cluster together owing to the magnetic properties.

As an alternative to the Massart process, only the oxidation process described for the first time by Sugimoto and Matijevic has established itself to date (Sugimoto et al., J. Colloid Interface Sci. 74, 227, 1979). This process does not use a stoichiometric mixture of Fe(II) and Fe(III), but instead only an Fe(II) salt solution. Firstly dark-green Fe(OH)₂ (so-called “green rust”) is precipitated from an Fe(II) salt solution in alkaline medium, and is subsequently oxidised to very pure crystalline magnetite by an added oxidant at elevated temperature. The oxidant employed is generally nitrate, but other oxidants, such as atmospheric oxygen, can in principle also be used. The particles obtained using this method can vary in size within certain limits through a suitable choice of the reaction conditions. However, they are, at an average of 50-200 nm, significantly larger than those described hitherto and are thus also not superparamagnetic.

A further process for the production of magnetic or magnetisable iron-oxide particles is found in the unpublished DE 102008015365.6 or the corresponding WO 2009/115176.

The person skilled in the art is able to select suitable magnetic or magnetisable particles, depending on the area of application of the moulding according to the invention. In making this choice, he will consider, for example, the toxicological properties and/or size of the particles. The size of the particles influences on the one hand the magnetic properties thereof and on the other hand also the processing thereof during production.

It has furthermore been found that particles whose surface has been completely or partly functionalised by means of hydrophilic functional groups, such as, for example, hydroxyl groups, are distributed particularly homogeneously in the moulding during production.

The functionalisation of the surface by means of hydrophilic groups can be carried out, for example, by covalent bonding of suitable functionalities or by coating of the particles.

Particular preference is given in accordance with the invention to the use of magnetic or magnetisable particles whose surface has a coating with SiO₂ and/or Al₂O₃ and/or TiO₂ and/or zirconium oxide. The coating of particles or pigments with these substances is known to the person skilled in the art. The coating can be carried out, for example, by wet-chemical methods or by means of chemical vapour deposition. Examples of suitable production processes are disclosed, for example, in DE 2106613 or EP 5,601,144.

The coated particles are produced, for example, by mixing the particles in aqueous suspension with the coating reagent. The coating reagent in the case of a coating with SiO₂ is composed of a water-soluble inorganic silicon compound and, if desired, further salts, such as, for example, aluminium salts and/or zirconium salts. The metal compounds can be metered into the suspension successively or simultaneously. Suitable inorganic silicon compounds are the aqueous solutions of alkali-metal silicates which are commercially available under the name “water-glass”, such as, for example, potassium water-glass and sodium water-glass. Sodium water-glass is preferably used in the post-coating. Suitable zirconium salts and aluminium salts are, in particular, the halides, nitrates and sulfates, preferably the chlorides. Precipitation of the silicon, zirconium or aluminium salts or hydroxides, oxides, which precipitate on the particles distributed in the suspension, is effected by suitable pH and temperature conditions.

Coating by means of acid precipitation is also possible. In this case, the particles to be coated are initially introduced in aqueous acidic solution. The pH of the aqueous acidic solution is typically adjusted using HCl and NaOH. In general, a pH of between 1 and 4, preferably between 1.5 and 3, is set.

The coating solution is then added. If it is desired to produce a coating with titanium dioxide, this is, for example, a TiOCl₂ solution. The addition is typically carried out by dropwise addition with stirring at room temperature. The mixture is subsequently conditioned at a temperature of typically between 40 and 100° C. over a period of 5 minutes to 5 hours, preferably with stirring or shaking.

The coated particles obtained are typically filtered off with suction and rinsed. The particles can then be dried by means of vacuum and/or heating. In addition, the particles can finally be calcined.

Preference is given in accordance with the invention to the use of particles which have not been calcined, since uncalcined particles have a greater number of hydroxyl groups.

The object according to the invention is achieved by the production of porous mouldings into whose skeleton magnetic or magnetisable particles have been polymerised. In this way, magnetic or magnetisable materials are created which have a large surface area available for adsorption/desorption or for the organic solid-phase reaction.

The mouldings according to the invention have at least macropores having a diameter of greater than 0.1 μm which serve as through-flow pores. The macropores typically have diameters of between 0.1 and 5 μm, preferably between 0.5 and 3.5 μm. In a preferred embodiment, the moulding has a bimodal or oligomodal pore distribution, in which, in addition to the macropores, mesopores, for example, having a pore diameter of between 2 and 200 nm, preferably between 5 and 50 nm, are also present. In a particularly preferred embodiment, the mesopores are located in the walls of the macropores and thus increase the surface area of the moulding.

The macropores are typically measured by means of mercury porosimetry, while the mesopores are determined by nitrogen adsorption/desorption by the BET method.

The total pore volume of the mouldings according to the invention is typically between 1 ml/g and 4 ml/g, preferably between 1.5 ml/g and 3.5 ml/g. The surface area of the mouldings according to the invention is typically between 50 m²/g and 750 m²/g, preferably between 100 m²/g and 500 m²/g.

The mouldings according to the invention are preferably produced by a sol-gel process. Sol-gel processes are known to the person skilled in the art. Examples of suitable processes for the production of monolithic mouldings are given, for example, in WO 98/29350 or WO 95/03256. The mouldings can be produced, for example, by hydrolysing and polycondensing alkoxysilanes in a gelling mould under acidic conditions in the presence of a pore-forming phase, for example an aqueous solution of an organic polymer, to give a porous gel body. The gel is then aged, and finally the pore-forming substance is separated off.

A typical example of a production process which is suitable in accordance with the invention is a sol-gel process in which organoalkoxysilanes and/or alkoxysilanes, such as tetramethoxysilane (TMOS) or tetraethoxysilane (TEOS), or mixtures thereof, are employed as precursor for the formation of the silica-gel structure and a template or porogen, for example PEO (polyethylene glycol), is employed for the formation of the macropore structure. The two components are initially introduced in acidified solution.

Hydrolysis and polycondensation occur. During the polycondensation, a point is reached at which so-called spinodal separation of the two phases (silicate-rich and aqueous, methanolic phase comprising dissolved PEO) occurs. The silicate framework forms, which forms an interconnected network and is interrupted by transport pores (=through-flow pores).

For the preparation of the materials according to the invention having a bimodal pore distribution, the mouldings can be treated, after the polycondensation, with reagents which attack the skeleton of the moulding. These are, for example, basic solutions, such as ammonia solution, or acidic solutions, such as, for example, HF solutions. Details are given in WO 95/03256.

Mouldings having a bimodal pore distribution are preferably produced in accordance with WO 98/29350 by adding reagents which, for example on heating, liberate a substance which attacks the silica skeleton of the moulding to the reaction mixture before the polycondensation. Examples of substances of this type are given in WO 98/29350. Urea is preferably employed for this purpose. In the case of urea, ammonia forms on heating.

Thus, the skeleton of the moulding is partially attacked either by aftertreatment with, for example, ammonia solution or by addition of, for example, urea to the reaction mixture followed by thermal treatment for the decomposition of the urea, and micro- and/or preferably mesopores form in the skeleton and thus also in the walls of the macropores (through-flow pores). In this way, mouldings are produced which allow both rapid and effective substance transport through the through-flow pores and also have a large surface area, for example for adsorption or solid-phase reactions.

In the case of the production of silica-gel hybrid mouldings, the organic, non-hydrolysable radicals may also themselves effect the formation of porous structures in the moulding.

The macropore formation can be supported, both in the case of silica-gel mouldings and also in the case of silica-gel hybrid mouldings, by the following detergents: for example cationic detergents, such as CTAB (CH₃(CH₂)₁₅N⁺(CH₃)₃Br⁻) nonionic detergents, such as PEO (polyethylene glycol), Brij 56 (CH₃(CH₂)₁₅—(OCH₂CH₂)₁₀—OH), Brij 58 (CH₃(CH₂)₁₅—(OCH₂CH₂)₂₀—OH) and Triton® X detergents (CH₃)₃CCH₂CH(CH₃)—C₆H₄O—(CH₂CH₂O)ₓH, where x=8 (TX-114) or x=10 (TX-100), or block copolymers, such as Pluronic® P-123 (EO)₂₀(propylene oxide, PO)₇₀(EO)₂₀ or Tween® 85 (polyoxyethylene sorbitan trioleate).

In a preferred embodiment, the mesopores are formed by means of an ageing process, as disclosed, for example, in WO 95/03256 and particularly in WO 98/29350 (addition of a thermally decomposable substance, such as urea).

By addition of magnetic or magnetisable particles at a suitable point in the reaction, in particular before commencement of the polycondensation, these can then be incorporated into the skeleton structure of the moulding. The resultant mouldings subsequently exhibit magnetic properties.

The particles are preferably added at the same time as or directly after mixing of the other reagents, i.e. after preparation of the acidic aqueous solution, which typically comprises at least alkoxysilanes and/or organoalkoxysilanes as precursor for the formation of the silica-gel structure and a porogen for the formation of the macropore structure, as well as optionally, for example, urea as precursor for a skeleton-attacking substance. The mixture is also stirred briefly in order that effective mixing takes place, and the polycondensation is then carried out in a suitable gelling mould.

The gelling moulds used are preferably moulds made from plastic or glass, particularly preferably made from silanised glass.

The process according to the invention gives monolithic mouldings into which magnetic or magnetisable particles have been polymerised.

The monolithic mouldings can be subjected to thermal treatment after the polycondensation, for example for supporting the ageing, separating off the porogens, for the formation of mesopores, etc. The thermal treatment is typically carried out at temperatures between 30 and 300° C.

The mouldings according to the invention can be completely or partly surrounded by a sheath layer. On the one hand, this sheath layer can be a solid cladding or the like, as is known, for example, for cartridges or chromatography columns. On the other hand, it can be a permeable, for example perforated, mesh-like sheath or a permeable or semipermeable membrane, for example a dialysis film.

The sheath layer can serve, for example, to mechanically stabilise the monolithic body or alternatively also—in particular in the case of semipermeable membranes—to increase the selectivity of the separation of target molecules/analytes.

In addition, it is possible to modify the surface of the mouldings according to the invention. This is typically carried out via covalent bonding of further functionalities, also known as separation effectors, to the surface of the mouldings. The covalent bonding to the moulding preferably takes place via silanes. Silanes in the sense of the present invention are all Si-containing compounds which have at least one functionality with which they are able to form a covalent bond to the moulding (corresponds to L in formula A), and at least one functionality which can serve as separation effector (corresponds to R in formula A). In general, these are mono-, di- or trifunctional silanes, such as alkoxy- or chlorosilanes. Other reactive Si-containing compounds, such as silazanes, siloxanes, cyclic siloxanes, disilazanes and disiloxanes, also fall under the term “silanes” in accordance with the invention.

Examples of suitable silanes are given by formula A,

LₙRₘSi A

where

1m≦3 and

1n≦3

and where n+m together gives 4,

L is Cl, Br, I, C1-C5 alkoxy, dialkylamino or trifluoromethane-sulfonate, and

R is straight-chain or branched C1 to C30 alkyl (such as, for example, methyl, ethyl, n-propyl, isopropyl, n-butyl, tert-butyl, sec-butyl, cyclohexyl, octyl, octadecyl), alkenyl, alkynyl, aryl (such as phenyl) or alkaryl (such as C1-C5-phenyl), cyano or cyanoalkyl (such as cyanopropyl), aminoalkyl or hydroxyalkyl (such as aminopropyl or propyldiol), nitro, ester, ion exchanger, etc.

R here in the case of m=2 or 3 may also have two or three different meanings, so that one to three identical or different radicals R may be present in one molecule.

More precise details on the reagents are known to the person skilled in the art and are given, for example, in K.K. Unger, Porous Silica, Elsevier Scientific Publishing Company, 1979.

Examples of particularly suitable separation effectors are ionic, hydrophobic, chelating or chiral groups, for example ionic groups, such as the carboxy) or sulfonyl group, as suitable for cation exchange chromatography, alkylated amino or ammonium groups, as suitable for anion exchange chromatography, long- and medium-chain alkyl groups or aryl groups, as suitable for reversed-phase chromatography.

Further details on possible separation effectors and suitable silanes are given in WO 94/19687, in particular on pages 4 and 5.

The silanes may likewise also have at least one reactive functional group which can subsequently be reacted, for example, with ligands, such as saccharides, nucleic acids, peptides or proteins or also catalytically active functionalities. The silanes may likewise themselves carry ligands, such as saccharides, nucleic acids, peptides or proteins.

A preferred method of introduction of, in particular, saccharidic separation effectors is disclosed in WO 2006084461.

The possible applications of the mouldings according to the invention are multifarious. Some examples are given below:
The mouldings according to the invention can be employed for the adsorption of polar substances for sample enrichment.
The mouldings according to the invention can be employed as the solid phase for solid-phase reactions, such as, for example, peptide or oligonucleotide syntheses.
The mouldings according to the invention can be derivatised by means of hydrophobic functionalities, such as C18-, C8-, C4-, etc., silanes, and can be employed for the adsorption of hydrophobic molecules.
The mouldings according to the invention can be derivatised by means of suitable silanes (containing functional end groups) and can be used for the immobilisation of proteins, antibodies and for the adsorption of biologically relevant substances.
The mouldings according to the invention can be provided with chiral separation effectors. In this way, one enantiomer from an enantiomeric mixture can be adsorptively bound, while the other enantiomer remains in solution. In this way, simple and selective enantiomeric is facilitated.
Reactants which are important for organic synthesis can be immobilised on the mouldings according to the invention and used for synthesis. The reactant or catalyst here is strongly bonded to the moulding and can be removed comfortably from the reaction solution, for example by means of a magnetic bar, when the reaction is complete. Reactants of this type can be, for example, acids or bases or redox partners, which, although participating in the reaction, themselves leave the reaction in unchanged form.
The mouldings according to the invention can be placed in a type of “pre-column holder” or cartridge after adsorption of analytes and installed upstream of a chromatography column. A suitable mobile phase is subsequently pumped through the coupled device, with the adsorbed analytes being desorbed from the moulding and transferred to the chromatography column. Qualitative and also quantitative analysis can then be carried out on the chromatography column by means of suitable HPLC or LC/MS systems. Coupling to another analysis device, such as, for example, a mass spectrometer, can likewise take place.

The mechanical stability of the monolithic mouldings produced in accordance with the invention even allows them to be employed as magnetic stirrers in reaction solutions. Since the moulding according to the invention has through-flow pores, suitable analytes are able to diffuse through the moulding and can be adsorptively bonded to the internal surface. Large surface areas are necessary for this purpose in order to be able to bind a sufficiently high concentration of the analyte. The surface area of the mouldings according to the invention can be increased further by the additional formation of mesopores.

This offers the possibility of adsorbing and separating desired target molecules from the solution during mixing of a reaction solution. This enables, for example, the reaction equilibrium of a reaction to be shifted specifically to the side of a desired reaction product and the yield to be increased. At the same time, this process enables simple separation of a reaction product from the reaction solution by removing the magnetic moulding used as stirrer from the reaction solution in a simple manner with the aid of a magnet. For desorption of the desired molecules, the magnetic separation element is introduced, for example, into a new, suitable solution. The desorption process can be accelerated by stirring on a magnetic stirrer. A suitable eluent can also be passed through the moulding used as stirrer in a suitable holder, such as a separating column, in order to separate off and isolate the adsorbed target molecules.

Whereas conventional magnetic particles have only very small surface areas, magnetic monoliths produced in accordance with the invention, which comprise a comparable amount of magnetic particles, may have, by comparison, a surface area which is larger by a factor of 10-15. This has the advantage that on the one hand the adsorptive properties of the moulding can be used for the separation of the target molecules, but on the other hand the magnetic properties of the polymerised particles can be used to simplify separation from the reaction solution. As already mentioned, the magnetic or magnetisable mouldings produced in accordance with the invention can be removed easily and in seconds from a reaction solution by means of a magnetic bar. Complex devices, as in the case of individual magnetic particles, are unnecessary in order to bind the particles via a magnet and to obtain the supernatant solution.

The present description enables the person skilled in the art to apply and carry out the invention comprehensively. Even without further comments, it is therefore assumed that a person skilled in the art will be able to utilise the above description in the broadest scope.

In the case of any lack of clarity, it goes without saying that the cited publications and patent literature should be used. Correspondingly, the complete disclosure content of all applications, patents and publications mentioned above and below, in particular the corresponding application DE 10 2009 017943.1, filed on Apr. 17, 2009, is incorporated into this application by way of reference.

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

It furthermore goes without saying to the person skilled in the art that, both in the examples given and also in the remainder of the description, the component amounts present in the compositions always add up only to 100% by weight or mol %, based on the composition as a whole, and cannot go beyond this, even if higher values could arise from the per cent ranges indicated. Unless indicated otherwise, % data are regarded as % by weight or mol %, with the exception of ratios which are shown in volume data, such as, for example, eluents, for the preparation of which solvents are used as a mixture in certain volume ratios.

The temperatures given in the examples and description and in the Claims are always in ° C.

### EXAMPLES

### Comparative Examples

Magnetic monoliths were produced in accordance with the publication by Leventis et al. (Nano Lett. Vol. 2, 2003, pp. 63-66) under the influence of an NMR magnet, characterised by means of BET and SEM photomicrographs and investigated for magnetic properties.

### Comparative Example 1

Two solutions A and B are prepared. Solution A comprises the silica precursor dissolved in methanol. Solution B comprises the alkaline catalyst for the sol-gel reaction and the magnetic particles suspended in water/methanol.

Solution A: 4.414 ml of TMOS in 3.839 ml of methanol

Solution B: 4.414 ml of methanol, 1.514 ml of water, 20 μl of conc. NH₄OH, 57 mg of magnetic particles.

The two solutions are combined at room temperature, mixed well and placed on the magnet. The sol-gel forms after 5-10 minutes. The magnetic particles align in different ways on the magnet. The monoliths produced in this way are left to stand at room temperature for 2 days. They are subsequently washed with the following solutions: ethanol, acetone and subsequently dried at low temperature in a drying cabinet.

For comparison, monoliths in which different magnetic particles are employed are produced in accordance with this example:

| | | |
|---|---|---|
| a) | without magnetic particles | |
| b) | Microna Matte Black | Art. No. 17437 (Merck KGaA) |
| c) | Mica Black | Art. No. 17260 (Merck KGaA) |
| d) | iron particles (10 μm) | Art. No. 1.03819.0100 (Merck KGaA) |

Result:

Colour:

The monoliths obtained are all clear and transparent. A part of the monolith without particles is yellow.

The glassy appearance of the monoliths produced in accordance with Leventis et al. confirms that they have no transport pores and no interconnected porosity (see SEM photomicrographs).

Strength:

The monoliths obtained are not dimensionally stable, but instead “crumbly” and cannot be obtained as a monolith.

Distribution of the Particles in the NMR:

The particles only rise about 3 cm in the test tube and are aligned at the wall of the test tube which faces the NMR.

Shrinkage Behaviour:

All monoliths have a strong shrinkage behaviour.

Magnetic Properties:

Magnetic properties are detectable in the case of all monoliths with the various particles.

BET Measurements:

TABLE 1

| | Surface area | Pore volume | Pore size |
|---|---|---|---|
| | S_{spec}(m²/g) | (cm³/g) | (Å) |
| KK 001 | 711.05 | 0.84 | 47.29 |
| KK 001 + iron | 607.97 | 0.53 | 34.69 |
| KK 001 + | 523.56 | 0.58 | 44.33 |
| Microna | | | |
| KK 001 + Mica | 604.46 | 0.57 | 37.66 |

The BET measurements show that the magnetic monoliths produced in accordance with Leventis are those which, although having large surface areas, are only caused by mesopores between 3.5 and 4.7 nm. The total pore volume of 0.53 to 0.84 cm³/g, which is, however, quite small, likewise shows that these materials have no macroporous through-flow pores.

SEM Photomicrographs:

The SEM photomicrographs do not show any uniform structures which suggest a bimodal pore system with macropores. Instead, fragments of polymerised-through silica gels, in some cases with smooth surfaces, are evident. The added particles are likewise evident in the SEM photomicrographs.

### Examples According to the Invention

### Example 1

10.2 g of PEO, 9.0 g of urea and 50 ml of TMOS are dissolved in 100 ml of 0.01 N acetic acid with cooling and warmed to a temperature of 30° C. 5 g of magnetic particles, Mica Black, Art. 1.17260 (Merck) are subsequently stirred into the solution, and the mixture is introduced into tubes for final gelling, where they are left for about 18 hours. They are subsequently aged for about 24 hours in a fan-assisted drying cabinet at elevated temperature (80-110° C.), removed from the tubes, washed with water and water/ethanol and dried overnight at 40° C.

In this way, black-marbled monoliths are obtained which have a total pore volume of 2.05 ml/g. 82% thereof can be ascribed to macropores having a size of 2 pm and 18% to mesopores having a size of 11.8 nm (all determined by mercury porosimetry measurements). Furthermore, an S_{BET} surface area of 120.9 m²/g can be determined by nitrogen adsorption.

SEM photomicrographs show the classical monolith structure with a connected silica-gel skeleton interrupted by macropores. The polymerised Mica Black particles are clearly evident.

The resultant monoliths can be held using a bar magnet. They can likewise be introduced into an MeOH-filled beaker and stirred on a magnetic stirrer.

### Example 2

10.2 g of PEO, 9.0 g of urea and 50 ml of TMOS are dissolved in 100 ml of 0.01 N acetic acid with cooling and warmed to 30° C. 5 g of magnetic particles, Microna Matte Black, Art. 1.17437 (Merck) are subsequently stirred into the solution, and the mixture is introduced into tubes for final gelling, where they are left for about 18 hours. They are subsequently aged for about 24 hours in a fan-assisted drying cabinet at elevated temperature (80-110° C.), removed from the tubes, washed with water and water/ethanol and dried overnight at 40° C.

Black-marbled monoliths are obtained which have a total pore volume of 2.86 ml/g. 72% thereof can be ascribed to macropores having a size of 0.95 pm and 28% to mesopores having a size of 10.6 nm (all determined by mercury porosimetry measurements). Furthermore, an S_{BET} surface area of 236 m²/g can be determined by nitrogen adsorption.

SEM photomicrographs show the classical monolith structure with a connected silica-gel skeleton interrupted by macropores. The polymerised Microna Matte Black particles are evident.

The resultant monoliths can be held using a bar magnet. They are likewise introduced into an MeOH-filled beaker and stirred on a magnetic stirrer.

### Example 3

10.2 g of PEO, 9.0 g of urea and 50 ml of TMOS are dissolved in 100 ml of 0.01 N acetic acid with cooling and warmed to 30° C. 2 g of magnetic particles, Mica Black, Art. 1.17260 (Merck) are subsequently stirred into the solution, and the mixture is introduced into tubes for final gelling, where they are left for about 18 hours. They are subsequently aged for about 24 hours in a fan-assisted drying cabinet at elevated temperature (80-110° C.), removed from the tubes, washed with water and water/ethanol and dried overnight at 40° C.

Black-marbled monoliths are obtained which have a total pore volume of 2.9 ml/g. 77.7% thereof can be ascribed to macropores having a size of 1.78 μm and 22.3% to mesopores having a size of 10 nm (all determined by mercury porosimetry measurements). Furthermore, an S_{BET} surface area of 279 m²/g can be determined by nitrogen adsorption.

The resultant monoliths exhibit magnetic properties and can be held using a bar magnet.

### Example 4

10.2 g of PEO, 9.0 g of urea and 50 ml of TMOS are dissolved in 100 ml of 0.01 N acetic acid with cooling and warmed to 30° C. 2 g of magnetic particles, Microna Matte Black, Art. 1.17437 (Merck) are subsequently stirred into the solution, and the mixture is introduced into tubes for final gelling, where they are left for about 18 hours. They are subsequently aged for about 24 hours in a fan-assisted drying cabinet at elevated temperature (80-110° C.), removed from the tubes, washed with water and water/ethanol and dried overnight at 40° C.

Black-marbled monoliths are obtained which have a total pore volume of 3.1 ml/g. 77.6% thereof can be ascribed to macropores having a size of 1.68 μm and 22.4% to mesopores having a size of 10.5 nm (all determined by mercury porosimetry measurements). Furthermore, an S_{BET} surface area of 287 m²/g can be determined by nitrogen adsorption.

The resultant monoliths exhibit magnetic properties and can be held using a bar magnet.

### Example 5

### Modification by Means of Separation Effectors

3 cm of a magnetic monolith (i.d. about 4.6 mm) as described under Example 1 (using 3 g of Mica Black) are added to a solution of 20% of aminopropyltrimethoxysilane (v/v) in anhydrous toluene and boiled under reflux at 110° C. for about 10 hours. The moulding is then washed with toluene and heptane.

### Example 6

### Use Example

3 cm of a magnetic monolith (i.d. about 4.6 mm) as described under Example 1 (using 3 g of Mica Black) are added to a solution of 5 ml of heptane/dioxane (95/5 v/v) containing 2-, 3- and 4-nitroacetophenone (42.5, 30 and 15 mg respectively) and stirred overnight. The magnetic monolith is then removed from the solution and stirred twice for 2 h in 5 ml of ethyl acetate each time in order to desorb the adsorbed samples again. The ethyl acetate is blown off using nitrogen, and the residue is again taken up in heptane/dioxane 95/5; (v/v). Recovery rates are subsequently determined by means of quantitative HPLC. 90-100% of the sample can be desorbed from the monolith. Sample is no longer found in the starting solution.

1. Moulding having through-flow pores which comprises magnetic or magnetisable particles.

2. Moulding according to claim 1, characterised in that the moulding essentially consists of silica gel or silica-gel hybrid materials.

3. Moulding according to claim 1, characterised in that the moulding comprises magnetic or magnetisable particles which have a core or layer of iron oxide, such as maghaemite (—Fe₂O₃) or magnetite (Fe₃O₄).

4. Moulding according to claim 1, characterised in that the moulding comprises magnetic or magnetisable particles whose surface has hydroxyl groups.

5. Moulding according to claim 1, characterised in that the moulding has a bimodal pore distribution with macroporous through-flow pores having a pore diameter of greater than 0.1 μm and mesopores having a pore diameter of between 2 and 200 nm.

6. Moulding according to claim 1, characterised in that the moulding has a cylindrical shape.

7. Moulding according to claim 1, characterised in that the moulding has been functionalised by means of separation effectors.

8. Moulding according to claim 1, characterised in that the moulding is completely or partly surrounded by a sheath layer.

9. Process for the production of mouldings having through-flow pores which comprise magnetic or magnetisable particles by a sol-gel process in which magnetic or magnetisable particles are added to the reaction mixture.

10. Process according to claim 9, characterised in that magnetic or magnetisable particles whose surface has hydroxyl groups are added.

11. Process according to claim 9, characterised in that the reaction mixture comprises alkoxysilanes and/or organoalkoxysilanes.

12. Use of the mouldings according to claim 1 for the enrichment or isolation of analytes from liquid media, as support materials for solid-phase reactions, as support materials for catalysts, enzymes or other reactants.

13. Use according to claim 12, characterised in that the moulding is used as stirrer bar in a liquid medium.

14. A method for the enrichment or isolation of analytes from a liquid medium, which comprises contacting the liquid medium with a moulding according to claim 1.

15. A support material for a liquid phase reaction which comprises a moulding according to claim 1.

16. A support material for a catalyst or enzyme which comprises a moulding according to claim 1.
